(19) United States
(12) Patent Application Publication
(10) Pub. No.: US 2022/0236720 A1
(43) Pub. Date: Jul. 28, 2022

(54) INTELLIGENT MANUFACTURING SYSTEM

(71) Applicants: Qingdao Haier Institute of Industrial Intelligence Co., Ltd., Qingdao, Shandong (CN); Haier Digital Technology (Qingdao) Co., Ltd., Qingdao, Shandong (CN); Haier Cosmo lOT Ecosystem Technology Co., Ltd., Qingdao, Shandong (CN)

(72) Inventors: Weijie Zhang, Qingdao, Shandong (CN); Siyu ZHAO, Qingdao, Shandong (CN); Weicun CUI, Qingdao, Shandong (CN); Yong WANG, Qingdao, Shandong (CN); Xiang GAN, Qingdao, Shandong (CN)

(21) Appl. No.: 17/596,504

(22) PCT Filed: Jul. 17, 2020
(86) PCT No.: PCT/CN2020/102668

§ 371 Date: Dec. 10, 2021

(30) Foreign Application Priority Data
Nov. 28, 2019 (CN) 201911193381.9

(51) Int. Cl. G05B 19/418

(52) U.S. Cl. CPC G05B 19/41865; G05B 2219/32082

(57) ABSTRACT

Provided is an intelligent manufacturing system. The intelligent manufacturing system includes a demonstration line site layer, a network transmission and cloud service layer and a display terminal layer. The demonstration line site layer includes a production line and an information collection subsystem. The production line is configured to produce a product, and the information collection subsystem is configured to collect production information of the production line. The network transmission and cloud service layer is configured to acquire and transmit the production information collected by the information collection subsystem. The display terminal layer is configured to receive and display the production information.

### CROSS-REFERENCE TO RELATED APPLICATIONS

This is a U.S. National Stage Application, filed under 35 U.S.C. 371, of International Patent Application No. PCT/CN2020/102668, filed on Jul. 17, 2020, which claims priority to Chinese Patent Application No. 201911193381.9 filed on Nov. 28, 2019, the contents of which are incorporated herein by reference in their entireties.

### TECHNICAL FIELD

The present application relates to manufacturing technologies, for example, an intelligent manufacturing system.

### BACKGROUND

Industrial manufacturing is referred to as manufacturing industry. In China, processing industry manufacturing refers to the industry in which according to the market requirements, manufacturing resources are transformed through a manufacturing process into industrial products and consumer goods that can be used and utilized by people. At present, as the pillar industry of our national economy, manufacturing industry is the leading sector of our economic growth and the foundation of the economic transformation. As an important support for economic and social development, manufacturing industry is the main channel for our urban employment and the concentrated reflection of international competitiveness.

However, at present, during an industrial production and manufacturing process, a management person cannot immediately get the fault information when a production device cannot work normally, affecting the production capacity; and fails to troubleshoot a process step when a quality problem occurs after production, affecting the product yield.

### SUMMARY

The present application provides an intelligent manufacturing system that can deal with the problems of poor production capacity and poor production yield in an industrial production and manufacturing process.

An embodiment of the present application provides an intelligent manufacturing system. The intelligent manufacturing system includes a demonstration line site layer, a network transmission and cloud service layer and a display terminal layer.

The demonstration line site layer includes a production line and an information collection subsystem. The production line is configured to produce a product, and the information collection subsystem is configured to collect production information of the production line.

The network transmission and cloud service layer is configured to acquire and transmit the production information collected by the information collection subsystem.

The display terminal layer is configured to receive and display the production information.

### BRIEF DESCRIPTION OF DRAWINGS

FIG. 1 is a schematic diagram of an intelligent manufacturing system according to an embodiment of the present application.

FIG. 2 is a schematic diagram of an intelligent manufacturing system according to an embodiment of the present application.

FIG. 3 is a schematic diagram of an intelligent manufacturing system according to an embodiment of the present application.

FIG. 4 is an information collection flowchart of an information collection and transmission module according to an embodiment of the present application.

### DETAILED DESCRIPTION

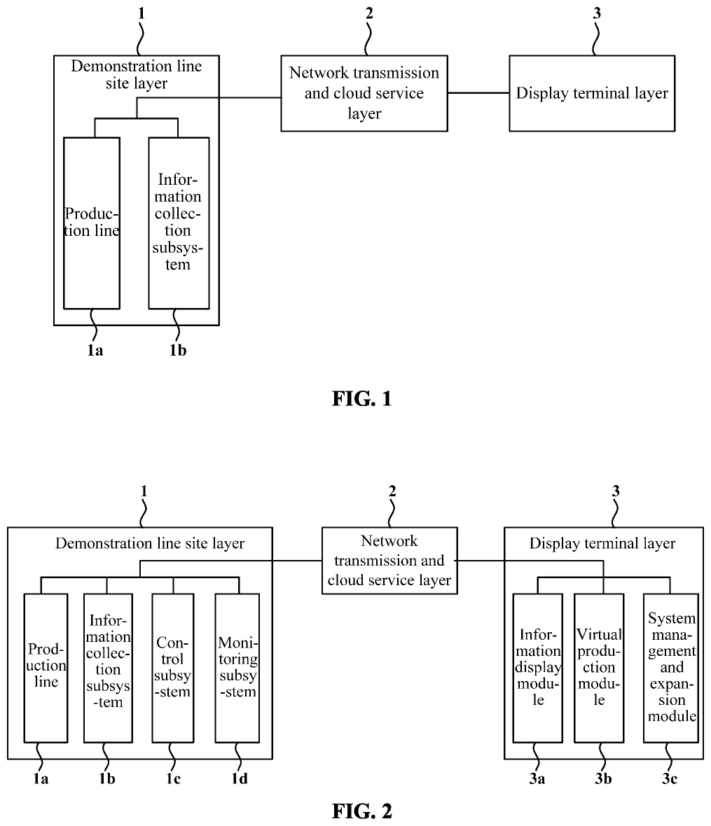

FIG. 1 is a schematic diagram of an intelligent manufacturing system according to an embodiment of the present application. In the present embodiment, the intelligent manufacturing system may be used for manufacturing various products such as washing machines, refrigerators and other electrical products based on industrial internet technologies and may also be used for manufacturing various models, souvenirs and small products with simple functions based on industrial internet technologies.

In the present embodiment, the intelligent manufacturing system includes a demonstration line site layer 1, a network transmission and cloud service layer 2 and a display terminal layer 3. The demonstration line site layer 1 includes a production line 1a and an information collection subsystem 1b. The production line 1a is configured to produce a product, and the information collection subsystem 1b is configured to collect production information of the production line 1a. The network transmission and cloud service layer 2 is configured to acquire and transmit the production information collected by the information collection subsystem 1b. The display terminal layer 3 is configured to receive and display the production information.

In the present embodiment, a demonstration line of the demonstration line site layer 1 refers to the production line 1a of the intelligent manufacturing system and a site of the demonstration line site layer 1 refers to a production site of the production line 1a. The demonstration line site layer 1 includes the production line 1a and the corresponding production structure. The production line 1a is configured to produce a product. In an embodiment, the production line 1a may be a production line for producing large-scale products such as washing machines, refrigerators and automobiles, may be a production line for producing small-scale products such as souvenirs and toys, or may be a demonstration production line for demonstrating a product production process.

The demonstration line site layer 1 further includes the information collection subsystem 1b that is configured to collect the production information of the production line 1a. The production line 1a produces a product, and the information collection system 1b collects the production information of the production line 1a in real time. The production information includes data such as an operating state and an operating parameter of a production assembly in the product line 1a, for example, an operating state and an operating parameter of a dual-arms robot. The production information further includes data such as a production state and a production parameter of a product in the production line 1a, for example, at least one parameter of a finished product after production. Exemplarily, the information collection subsystem 1b may basically acquire the data of the production line 1a, which is not illustrated one by one herein. In an embodiment, the production information includes the operating information of the production assembly in the production line 1a, such as state information and fault information. In an embodiment, the production information includes the quality information of a finished product. The demonstration line site layer 1 implements the production and the collection of the production information through internet technologies.

In the present embodiment, the network transmission and cloud service layer 2 is configured to acquire and transmit the production information collected by the information collection subsystem 1b. Exemplarily, the information collection subsystem 1b collects the production information of the production line 1a in real time and uploads the production information to a database. The network transmission and cloud service layer 2 acquires the production information stored by the information collection subsystem 1b from the database. In an embodiment, the production information stored in the database by the information collection subsystem 1b may be classified and stored, such as being stored according to time and date. For example, the production information within one week is stored together and overdue videos are classified and stored according to months, facilitating the network transmission and cloud service layer 2 to perform classified checks and data extraction. Exemplarily, the network transmission and cloud service layer 2 transmits the production information of the demonstration line site layer 1 to the display terminal layer 3 through network cloud. The transmission mode ensures the high security and high real-time transmission of production information data. In an embodiment, the network transmission and cloud service layer 2 includes a network server such a cloud server or a cloud disk. The network transmission and cloud service layer 2 performs the production information transmission based on internet technologies.

In the present embodiment, the display terminal layer 3 is configured to receive and display the production formation. Exemplarily, the demonstration line site layer 1 produces a product and collects a plurality of items of production information of the production line 1a at the same time. The network transmission and cloud service layer 2 extracts the production information of the production line 1a and transmits the production information to the display terminal layer 3 that then displays the production information related to the product. In the present embodiment, the display terminal layer 3 may display the production information of the demonstration line site layer 1 on a terminal in real time while the demonstration line site layer 1 produces a product in real time. In this manner, the real-time display and check of the production information are implemented. In an embodiment, the display terminal layer 3 includes a display terminal and the corresponding auxiliary display device. For example, the display terminal is a mobile terminal. Exemplarily, the display terminal layer 3 displays the production information. A manager may check whether the production device operates normally through the production information and immediately obtain the fault information according to the production information when the production device does not operate normally. The manager may also check whether a quality problem occurs after production through the production information. If such a problem occurs, the manager may troubleshoot the problematic step through checking the historical production information. The display terminal layer 3 displays the production information based on internet technologies.

In an embodiment, the demonstration line site layer 1 implements the production and the collection of the production information, such as real-time signals collection, Manufacturing Execution System (MES) data collection and site monitoring data collection, store the real-time signals and information system data through a time-series database and store the high-definition video data through a network.

In an embodiment, a Virtual Private Network (VPN) is constructed in the network transmission and cloud service layer 2, improving the security of data transmission. Moreover, the real-time performance and integrity of data transmission can be improved through the combination of a User Datagram Protocol (UDP) and a Transmission Control Protocol (TCP). Exemplarily, in an embodiment, the network transmission and cloud service layer 2 includes a cloud server on which web services are deployed. In this manner, the difficulty of the data transmission management by a server can be reduced, the security of data transmission in the intelligent manufacturing system can be improved, and the network transmission and cloud service layer 2 can be better adapted to other cloud platforms. Alternatively, the network transmission and cloud service layer 2 can also use a fluorite cloud service to reduce the access difficulty of a monitoring device so as to facilitate the management of a monitoring system and, at the same time, due to the flexible changes in the fluorite cloud service, can better cope with large concurrent access.

In an embodiment, the display terminal layer 3 may be a large display screen, an ordinary computer or a mobile terminal. Based on the internet technologies, a user may access a digital twin platform in the terminal through a browser in the display terminal layer 3. Moreover, the display terminal layer 3 may also use a Next-generation Versatile Disc (NVD), a hard decoding device in a scene where the display terminal layer 3 is located, to improve the decoding speed and definition of the production information, such as video data.

In the present embodiment, the demonstration line site layer 1, the network transmission and cloud service layer 2 and the display terminal layer 3 constitute the intelligent manufacturing system. The demonstration line site layer 1 performs real-time production through the production line 1a and real-time collection of the production information through the information collection subsystem 1b. The network transmission and cloud service layer 2 is configured to transmit the production information in real time through network. Finally, the display terminal layer 3 displays the production information. In the present embodiment, the intelligent manufacturing system is based on an industrial internet concept. The intelligent manufacturing system implements the intelligent informatization in a production and manufacturing process based on the internet technologies. The manager can check the production information of the production line 1a in the demonstration line site layer 1 at the display terminal layer in real time, thus enabling the monitoring and checking in the production process, solving the defect of complicated manual management in the related art and improving the intelligence of the manufacturing industry. Exemplarily, during an industrial production and manufacturing process, a manager can get the fault information immediately when a production device cannot operate normally, improving the production capacity; and can also troubleshoot a process step timely when a quality problem occurs after production, improving the product yield.

Exemplarily, on the basis of the above technical schemes, as shown in FIG. 2, in an embodiment, the demonstration line site layer 1 further includes a control subsystem 1c and a monitoring subsystem 1d. The control subsystem 1c is configured to control production of the production line 1a and the monitoring subsystem 1d is configured to monitor the production of the production line 1a. The information collection subsystem 1b is configured to collect production data of the production line 1a through the control subsystem 1c and is also configured to collect production video data of the production site of the production line 1a through the monitoring subsystem 1d. In an embodiment, the monitoring subsystem 1d includes a plurality of monitoring devices.

In the present embodiment, the demonstration line site layer 1 is configured to implement the product production and signal collection. Exemplarily, the production line 1a implements the product production. The control subsystem 1c controls the production line 1a to produce a product. The monitoring subsystem 1d collects a monitoring video of the production site. The information collection subsystem 1b collects the real-time signals, information system data and site monitoring video. In an embodiment, the information collection subsystem 1b may collect the production data of the production line 1a in real time through the control subsystem 1c, is also integrated with an information management module IVIES to collect the information system management data of the production line 1a and is also connected to the monitoring subsystem 1d to acquire the production video data of the production line 1a. The information collection subsystem 1b stores the collected real-time data of the production line 1a and MES data in the time-series database, acquires the collected high-definition production video data through the monitoring subsystem 1d and stores the high-definition production video data in the database.

In an embodiment, the monitoring subsystem 1d includes a plurality of monitoring devices. In an embodiment, the monitoring devices are networked monitoring cameras that are distributed at highlight stations and important procedure positions of the production line 1a so as to facilitate monitoring the production process of the production line 1a.

In an embodiment, the intelligent manufacturing system further includes a database that is configured to store data such that data are synchronized and transmitted between different subsystems.

The information collection subsystem 1b is known to transmit the production information to the display terminal layer 3 through the network transmission and cloud service layer 2. In this case, the intelligent manufacturing system further includes the database. The information collection subsystem 1b transmits the production information to the database. Then, the network transmission and cloud service layer 2 extracts the production information from the database and transmits the production information to the display terminal layer 3 for display. In an embodiment, the database is a database relying on the cloud server. The data stored in the database may be classified and stored, for example, by time and date, so as to facilitate the network transmission and cloud service layer 2 to extract data.

As shown in FIG. 2, in an embodiment the display terminal layer 3 includes an information display module 3a and a virtual production module 3b. The information display module 3a is configured to display the production data and production video data. The virtual production module 3b is configured to form, according to the production data and production video data, a virtual production line model and perform virtual production.

In the present embodiment, the display terminal layer 3 may directly display the production data to make is easier for a manager to judge the states of the production line 1a and the product produced by the production line 1a according to the production data, for example, troubleshooting the operating state of a product device, fault information of the product device under abnormal operating state, and the degree of completion of the product and troubleshooting a problematic procedure when a quality problem occurs after production.

In the present embodiment, the display terminal layer 3 may not only directly display the production data, but also establish the virtual production line model completely corresponding to the production line 1a of the demonstration line site layer 1 on the display terminal according to the production data and the production video data. The virtual production line model on the display terminal layer 3 is driven by the production data and production video data received by the display terminal layer 3. Exemplarily, the production line 1a of the demonstration line site layer 1 operates in real time; the production information such as the production data and production video data collected by the information collection subsystem 1b in real time is transmitted to the display terminal layer 3 through the network transmission and cloud service layer 2; the virtual production line model on the display terminal of the display terminal layer 3 operates synchronously; based on the internet technologies, the virtual production line model of the display terminal layer 3 implements the delayed synchronous operating with the production line 1a of the demonstration line site layer 1 and simulates the production process, enabling the integration of virtual production and real production. Through the display terminal layer 3, the manager can check the production information of the production line 1a and can also check the virtual production process and procedures of the production line 1a. Thus, the real-time monitoring is implemented.

In an embodiment, the display terminal layer 3 further includes a system management and expansion module 3c that is configured to perform user registration, login and authority management through user management. The function of the system management and expansion module 3c is to improve the security of the system, prevent other external person from modifying and checking the system and ensure the security and stability of product content.

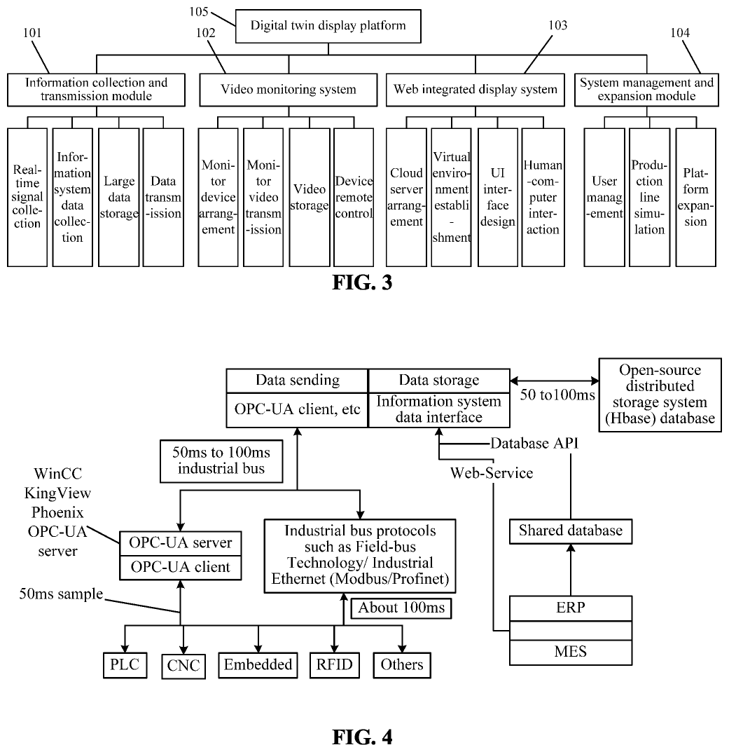

Exemplarily, on the basis of the above technical schemes, as shown in FIG. 3, in an embodiment, the intelligent manufacturing system is a demonstration line digital twin visualized virtual display system. Exemplarily, the above embodiment is a division and brief description of the intelligent manufacturing system from the information transmission flow. In the present embodiment, the digital twin visualized virtual display system is mainly described from a functional architecture briefly. The functional architecture is mainly divided into four core modules, namely, a signal collection and transmission module 101, a video monitoring system 102, a Web integrated display system 103 and a system management and expansion module 104. A digital twin display platform 105 is also included. In an embodiment, the digital twin display platform 105 may be a mobile terminal, a display large screen or a computer display terminal.

For the signal collection and transmission module 101, in the digital twin display platform 105, the movement of the virtual production line and the content displayed on the information interface are dynamically driven by a real-time control signal and information system (the IVIES) data of the demonstration line site layer 1. That is, the production information of the demonstration line site layer 1 drives the virtual production line to operate. In order for the digital twin display platform for digital twins (combination of virtual and real) to be implemented, the signal collection and transmission module 101 transmits a production-related signal and information data of the demonstration line site layer 1 to a display site and display terminal in real time, completely and safely. In an embodiment, the functions of the signal collection and transmission module 101 include collecting the real-time signal of the production line 1a, collecting the information system data of the production line 1a and storing and transmitting the collected large data. The real-time signal is the real-time production-related signal of the production line 1a. The information system data, also called information data, refers to the relevant data of the information system that monitors the production line.

FIG. 4 shows a signal and information data collection flowchart of the signal collection and transmission module 101.

The signal collection and transmission module 101 mainly uses Open Platform

Communications-Unified Architecture (OPC-UA) technology for the real-time signal collection. Exemplarily, the international standard OPC interface is used as a primary method for information transmission to enable the effective data transmission between the digital twin display platform 105 and the demonstration line site layer 1. OPC-UA is a new generation of industrial standard that provides a completely safe and reliable cross-platform architecture to acquire the time of real-time and historical data.

The signal collection and transmission module 101 mainly collects the information system data through Web service and a shared database so as to make the data synchronized and transmitted between different systems.

Additionally, in order to adapt to the high-frequency collection of the real-time signal and information system data, the signal collection and transmission module 101 mainly uses an open-source time-series database distributed storage system (Hadoop Database, Hbase) that is distributed and column-oriented for data storage. The traffic data of the digital twin display platform 105 uses MySQL, an open-source relational database, for data storage.

In order to improve the efficiency and accuracy of data transmission, the signal collection and transmission module 101 mainly uses a data transmission mode combining UDP and TCP for data transmission. In order to improve the security of network transmission, an Advanced Encryption Standard (AES) is used to encrypt the transmission content and a VPN virtual link is established.

The preceding is merely an exemplary description. The standards, protocols and modes of signal and information data collection of the signal collection and transmission module 101 are not limited to the preceding exemplary description. The data storage and transmission modes of the signal collection and transmission module 101 are not limited to the preceding exemplary description either.

The video monitoring system 102 is a Web-based video monitoring system that may provide the digital twin display platform 105 with a picture of the real-time state of the demonstration line site layer 1. In this manner, through a synchronous comparison between the production line 1a of the demonstration line site layer 1 and the virtual production line of the digital twin display platform 105, the manager can fully grasp the state of a demonstration line on the display terminal in real time without geographical restrictions and, at the same time, a foundation and data resource can be provided for enterprise publicity and future education platform construction. The video monitoring system 102 is divided into four parts, namely, monitoring device arrangement, monitoring video transmission, video storage and device remote control.

In an embodiment, the demonstration line site is deployed with a plurality of webcams above the 5-megapixel level. In an embodiment, the highlight stations are monitored by bullet cameras and a whole production line is monitored by dome cameras. The demonstration line site may also be deployed with a Network Video Recorder (NVR) that implements the high-definition recording of the production video of the demonstration line site with the help of a gigabit local area network at the demonstration line site.

Moreover, the cloud video server enables monitoring cameras in multiple places to access the network and provides support for people to watch online at the same time. In an embodiment, the cloud video server is a fluorite cloud video server. With the help of the plenty of external interfaces of the fluorite cloud video server, a video resource can be provided for a computer terminal, a mobile terminal application (APP), at least one display platform and a streaming media platform.

Additionally, the monitoring video may be stored in a distributed manner. The NVR network video recorder of the demonstration line site may store the video data of the last 1 to 3 months and the overdue video is transferred to the network cloud disk. The fluorite cloud video server may store the video data of the last 7 days for recent video playback. A complete process video may be stored in the network cloud server for use when the demonstration line site is disconnected from the internet or shut down. The display terminal of the display terminal layer may store the video data of the last 3 days and a complete process video for use when the demonstration line site is disconnected from the internet or shut down.

Based on web development, the demonstration line site monitors the control subsystem of the production line to implement the device start, stop and pan and tilt control of the monitored production line.

For the Web integrated display system 103, it is a web-based digital twin display system and deployed in a high-performance cloud server. The Web integrated display system 103 may perform domain name association without a public Internet Protocol (IP), implement remote login and display without the help of VPN and adapt to a platform and late expansion of at least one manufacturer. The digital twin display platform 105 uses a Browser/Server (B/S) structure. The Web integrated display system 103 is divided into four parts, namely, cloud server arrangement, virtual environment establishment, user interface (UI) design and human-computer interaction.

Based on the current most popular Unity three-dimensional (3D) engine, a three-dimensional virtual environment of a Web Graphics Library (WEBGL) is established. The WEBGL contains the real-time movement of the virtual production line and display of the information system interface. Moreover, the virtual production line may smoothly run on a general-configuration computer through a webpage with the WEBGL.

Based on html5, css3, echarts, Photoshop and other webpage front-end technologies, web interface design and development are implemented. In this manner, the real-time and historical data of the demonstration line site layer 1 can be displayed and the capability of a COSMOPlat platform can also be displayed.

In the webpage and WEBGL, the human-computer interaction operations may be performed. In an embodiment, the human-computer interaction operations include three-dimensional roaming, perspective switching, information interface pop-up, switching between different elements in webpages and switching between different webpages.

The system management and expansion module 104 may perform user registration, login, password modification and authority management through user management to improve the popularization and security of the digital twin display platform 105. The system management and expansion module 104 may analyze and tap the production capacity of the demonstration line through the virtual and real combination mode of the virtual product line to improve the design quality of the product line of the demonstration line. The system management and expansion module 104 may also perform platform expansion, mainly in-depth development. The system management and expansion module 104 may also be integrated with other cloud services to implement platform load balancing, high concurrency and timely response. The system management and expansion module 104 may also be adapted to the COSMOPlat platform of at least one manufacturer.

Based on the field of intelligent manufacturing industry internet platform, the present embodiment provides a visualized display system of an intelligent manufacturing demonstration line using the virtual-real integration technology and mainly provides an overall control flow of the intelligent manufacturing system and the layout interface design of the system.

In the present embodiment, a digital twin model of the demonstration line and a virtual-real display system of the demonstration line are constructed at the display terminal through the collection of real-time production, device, user and other data of the intelligent manufacturing demonstration line and real-time monitoring video of the demonstration line. The overall system has stable and effective architecture, comprehensive information display, safe data transmission, high real-time performance, strong compatibility of simulation model display and simple and clear interface design, thereby effectively improving the user experience of control of the intelligent manufacturing and production process.

In the present embodiment, the intelligent manufacturing system includes the production line of the demonstration line site layer and the virtual production line of the display terminal layer.

Here, the virtual production line and real production line may be construed as twin production lines based on the real scene of the demonstration line site layer. Exemplarily, the intelligent manufacturing system may be construed as the demonstration line digital twin visualized platform virtual display system with the function of real-time three-dimensional monitoring and monitoring video display constructed through the monitoring subsystem and the function of information display and process simulation constructed through the display terminal layer, so that the effects of the virtual-real integration display and interactive demonstration line can be achieved.

What is claimed is:

1. An intelligent manufacturing system, comprising: a demonstration line site layer, a network transmission and cloud service layer and a display terminal layer, wherein
the demonstration line site layer comprises a production line and an information collection subsystem, wherein the production line is configured to produce a product, and the information collection subsystem is configured to collect production information of the production line;
the network transmission and cloud service layer is configured to acquire and transmit the production information collected by the information collection subsystem; and
the display terminal layer is configured to receive and display the production information.

2. The intelligent manufacturing system of claim 1, wherein the demonstration line site layer further comprises a control subsystem and a monitoring subsystem, wherein the control subsystem is configured to control production of the production line, and the monitoring subsystem is configured to monitor production of the production line; and
the information collection subsystem is configured to collect production data of the production line through the control subsystem and collect production video data of a production site of the production line through the monitoring subsystem.

3. The intelligent manufacturing system of claim 2, wherein the monitoring subsystem comprises a plurality of monitoring devices.

4. The intelligent manufacturing system of claim 2, further comprising: a database, which is configured to store data such that data is synchronized and transmitted between different subsystems.

5. The intelligent manufacturing system of claim 2, wherein the display terminal layer comprises an information display module and a virtual production module, wherein
the information display module is configured to display the production data and the production video data; and
the virtual production module is configured to form a virtual production line model according to the production data and the production video data and perform virtual production.

6. The intelligent manufacturing system of claim 1, wherein the display terminal layer further comprises a system management and expansion module, wherein
the system management and expansion module is configured to perform user registration, login and authority management through user management.
